(19) United States
(12) Patent Application Publication
(10) Pub. No.: US 2015/0199481 A1
(43) Pub. Date: Jul. 16, 2015

(54) MONITORING SYSTEM AND METHOD

(71) Applicant: Response Care Inc., Rochester, NY (US)

(72) Inventors: Myron Kowal, Webster, NY (US); Richard Moore, Rochester, NY (US); Antonio Ferreira, Penfield, NY (US); Gregory Meade, Rochester, NY (US)

(73) Assignee: Response Care Inc., Rochester, NY (US)

(21) Appl. No.: 14/497,952

(22) Filed: Sep. 26, 2014

Related U.S. Application Data
(60) Provisional application No. 61/925,989, filed on Jan. 10, 2014.

(51) Int. Cl. G06F 19/00; G06Q 10/00; G06Q 50/22

(52) U.S. Cl. CPC G06F 19/327; G06Q 50/22; G06Q 10/00

(57) ABSTRACT

Disclosed is an automated, wireless system and method for tracking and recording the activities that are performed by caregivers such as nurses, aides, housekeepers, social workers, etc.

This application claims priority from U.S. Provisional Patent Application 61/925,989 for a MONITORING SYSTEM AND METHOD, filed Jan. 10, 2014 by M. Kowal, et al., which is hereby incorporated by reference in its entirety, including appendices.

The following disclosure is directed to a method and system for improving accountability in providing ongoing care to residents, such as elderly residents, within a living or nursing community. More particularly, the disclosed embodiments are directed to technology for the real time capture of data that reliably records events, including the time and place of actions performed, by a specific staff member (e.g., caregiver), on behalf of the residents (e.g., elderly) or patients, in conjunction with a centralized dispatch or control station. These resident care events are maintained in a database to document and generate reports relative to the level care provided to a resident, as well as to recognize opportunities for ongoing improvements and efficiencies.

### BACKGROUND AND SUMMARY

The aging of baby boomers has become a social and economic challenge. Due to the maturation of the baby boomer generation, in the United States alone, the number of people over the age of sixty-five is expected to hit 70 million by 2030, doubling from 35 million in 2000. With this aging population comes a necessity to develop more efficient and cost-effective methods for personal and health care monitoring, including recording of the care given to elders and other patients. Unfortunately, there are few systems designed to monitor the level of care rendered in nursing and similar adult-care facilities across the country. Adherence to an appropriate standard(s) of care requires some means of monitoring activities performed by staff as well as events and responses, and systems or methods designed for monitoring help provide accountability by maintaining adequate documentation. Accordingly, a comprehensive system and method to promote quality of care, as well as evidence of improper care (if that is the case), is needed to protect the residents, as well as the best interests of the care facilities from unfounded claims of neglect.

Wired and wireless communication devices, such as cell phones, tablets and laptops are commonly used to access communication networks, as well as broadband data networks that provide text messaging, email services, Internet access, and a variety of enhanced features such as streaming audio, video and a plurality of application specific software. Wireless telephones have operating systems that can run applications that perform additional features and functions. Apart from strictly wireless telephony and messaging, wireless hand held devices have become a general platform for functions associated with, for example, navigational systems, social networking, electronic organizers, audio/video players, shopping tools, and electronic games. Users have the ability to choose a wireless device and associated applications and networks that meet their particular needs. Examples of such infrastructures include personal communications service (PCS), general packet radio service (GPRS), global system for mobile communications (GSM), and integrated digital enhanced network (iDEN) to name a few. Additionally there are an abundance of application specific resident programs such as symbol decoding logic that is supported by using an optical image capture feature for the recognition of bar codes such as those used for universal product code (UPC) and quick response (QR) codes.

Recently a near field communication (NFC) wireless electromagnetic induction technology has become generally available in the 13.56 MHz band for use on mobile devices which have been enabled with a NFC application and hardware (e.g., sensor) for the touch-less transfer of data, such as text or numbers, between a NFC enabled device and a corresponding passive NFC tag. NFC tags, for example, are “stickers”, similar to RFID, but having a very limited range, containing a micro-memory chip with an antenna which can store and transmit a small amount of information (typically up to 4 Kb) to an active NFC decoding device, such as a mobile phone, that is within a few centimeters of the tag. The tag does not require a power source and is therefore inexpensive and maintenance free after installation.

The disclosed system and method relates to a monitoring and management of care, and does so by employing an NFC enabled device(s) to facilitate the easy gathering of care related data via a smartphone or similar device. The system and method further employ a database for providing accountability and tracking of care provided to the residents within a facility. A hand held device, such as a smart phone, is employed as a responder to a centralized dispatching computer system in order to alert the appropriate caregiver to the need for assistance or a specific task at an identified location. The central computer system may be responsive to a host of peripheral input devices including, but not limited to; wearable pennants, call buttons, fall monitors, medical device alarms, smoke detectors, motion detectors, door and window monitors, as well as including the ability to pre-program tasks.

Disclosed herein is a system and method for monitoring and recording the administration of services within a care facility, comprising: a plurality of tags, each tag including a RF signal detector operatively associated with a static data storage device, wherein each static data storage device include a unique identifier, and where said tags are permanently affixed at prescribed locations to provide a wireless data read feature when an RF signal is received; a hand held communication device, said hand held device including a housing, a memory, a microprocessor, a user interface (e.g. a display and keyboard), a start/stop timer, a real-time clock function, a RF transceiver and a battery, and where data transmission from said RF signal detector to said handheld device is activated by said hand held device being placed in proximity to said RF signal detector, wherein the data transmitted from said RF includes at least the unique identifier information; and a central processor suitable for communicating with each hand held device and receiving a stored accumulation of resident care data initially received from said stationary static memory device and stored on said hand held communication device, wherein the central processor is capable of storing and further processing the data received from each hand held device, including reporting such data, and where in response to a services prompt from said hand held communication device, a user responds to the services prompt and in doing so activates the RF signal detector to initiate a record of service delivery.

Also disclosed herein is a method for tracking performance of resident services, comprising: transmitting a prompt (e.g. a call for assistance by a resident; predefined task, etc.) to a caregiver's hand held device from a central computer station; the caregiver responding to the prompt; passing the hand held device near a tag associated with a resident's specified location, said tag, in response transmitting over a radio frequency (RF) to the hand held device at least an identifier permanently stored within a memory associated with the tag; in response to the RF transmission initiating an event timer in the hand held device; the caregiver responding to the prompt (e.g., executing the requested task); passing the hand held device near the tag associated with the resident's specified location in order to stop the event timer in the hand held device; recording service delivery information including the tag identifier, as well as the start and stop times in memory in the hand held device (e.g., prompt info, duration of services, date, caregiver ID, caregiver notes, etc.); and relaying the service delivery information to said central computer station.

Further disclosed in embodiments herein is a smart mobile phone application used for tracking and recording the activities that are performed by medical professionals, aides, housekeepers (aka caregivers) and other specialized staff members to establish the time and date they provide services, what tasks were accomplished while there, the time of departure.

Also disclosed herein is a system and method that tracks both the request for services as well as the actual fulfillment of such a request. As will be appreciated, the disclosed system and method enable the delivery of services to be monitored by supervisory personal. This data may be valuable as a management tool to provide sufficient staffing levels, evaluate performance, provide regulatory review reporting, etc. As described, the method and system enable the creation of an ongoing record of the services provided to residents. The nature of the services is likely to vary based upon the resident's need and the type of facility, but could include activities of daily living (ADL) such as those described at http://longtermcare.gov/the-basics/glossary/, or discussed by Joshua M. Wiener et al. in “Measuring the Activities of Daily Living: Comparisons Across National Surveys,” at http://aspe.hhs.gov/daltcp/reports/meacmpes.pdf (Journal of Gerontology: SOCIAL SCIENCES (Vol. 45, No. 6, S229-237)), the disclosures and information therein being hereby incorporated by reference. For example, in the embodiments disclosed herein the activities may include; dressing, bathing and/or showering, feeding, transfer (bed to chair or visa versa), personal hygiene, grooming, laundry and housekeeping functions, to name a few. These data along with the time stamp will be relayed or forwarded (e.g., via wireless telephone network, Wi-Fi, wired synch, etc.) to a host computer and stored in a database(s) maintained for reporting and analysis purposes.

### BRIEF DESCRIPTION OF THE DRAWINGS

FIG. 1 is an illustrative system diagram of the resident assistance network including a RF hand held responder and a static data tag;

FIG. 2 is a picture of a static data tag;

FIG. 3 is a picture of the hand held responder reading a static data tag;

FIG. 4 as seen in FIG. 3, the hand held device in use as an event timer;

FIG. 5 a screen rendition of the hand held device showing various feature;

FIG. 6 is an illustration of the comment feature overlaid on the user interface of FIG. 5;

FIGS. 7A-7B and 8A-8B are exemplary flowcharts illustrating operations carried out by the disclosed system; and

FIG. 9 is an illustration of the nature of a data report produced using data gathered by the disclosed embodiments.

The various embodiments described herein are not intended to limit the disclosure to those embodiments described. On the contrary, the intent is to cover all alternatives, modifications, and equivalents as may be included within the spirit and scope of the various embodiments and equivalents set forth. For a general understanding, reference is made to the drawings. In the drawings, like references have been used throughout to designate identical or similar elements. It is also noted that the drawings may not have been drawn to scale and that certain regions may have been purposely drawn disproportionately so that the features and aspects could be properly depicted.

### DETAILED DESCRIPTION

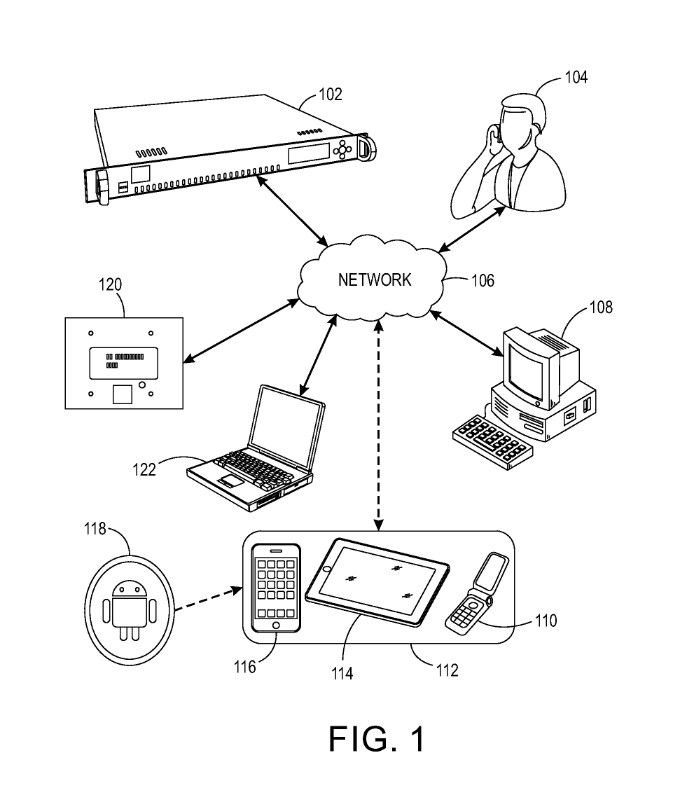

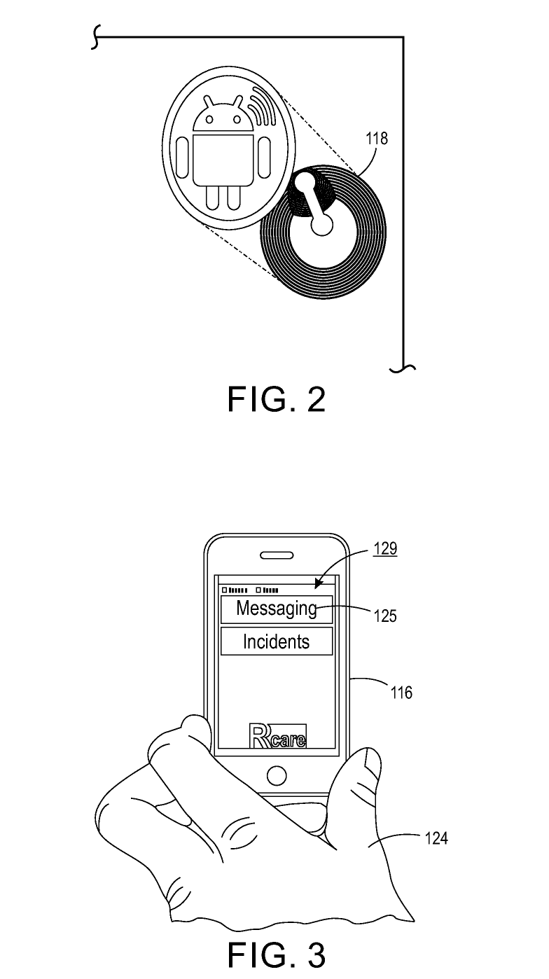

Referring to FIG. 1, depicted therein is an overview of a resident care management network within a care facility. Network 106, along with the central controller 102, provides the connectivity to various input monitoring devices that are responsive to a request (or indicated need), an alarm or a pre-scheduled task for assistance from a resident. The term “prompt” is used to generally represent such a request or task. Although not specifically shown in FIG. 1, the system may further include input monitoring devices such as a resident locator, wearable call pendant, call button, fall monitor, medical device alarms, smoke detectors, motion detectors, door and window monitors and so forth. For the most part these devices may be wired or wireless and transfer alert data to a central receiver. In one embodiment the system may employ Wi-Fi communication technology. The Wi-Fi receiver subsequently transfers data to the central controller 102, for example, via a hard-wired port (e.g., serial). Once the central controller 102 detects a call for service the operating system and programmatic code operating on the controller or a related computer system makes a determination as to (i) the nature of assistance required, (ii) the preferred responder and (iii) the location of the resident in need of assistance. Subsequently a message or prompt is transmitted to one or more caregivers. At the same time, the system may record a time at which the prompt was sent to the caregiver(s). Generally speaking the response receiver is a network node consisting of one or more of the following output devices; laptop 122, desktop 108, or a tablet computer 114 or preferably a hand held wireless devices such as mobile phone 110 or smart phone 116. Display unit 120 is a status monitor viewable within a central station or a manager's office, and may be implemented as an LED or LCD display, a user display on a workstation 108 or similar devices such as the laptop as well (122). In the event of a non-response, after a predefined time has elapsed, a further prompt may be sent to another caregiver and/or to an administrator 104 for immediate action. In the embodiment described below, the caregiver is understood to carry a hand held or portable device such as the mobile phone 110, tablet computer 114 or smart phone 116. Such devices, by necessity, must be suitable to activate and receive information from the near field communication (NFC) wireless tag 118, such as tags available from IDENTIVE NFC (http://www.identivenfc.com/en/nfc-tags.htm). As noted above, such tags employ electromagnetic induction technology in response to mobile devices which have been enabled with a NFC application and hardware for the touch less transfer of data. The data sent from the tag to the hand held device includes a unique identifier in the form of text or numbers.

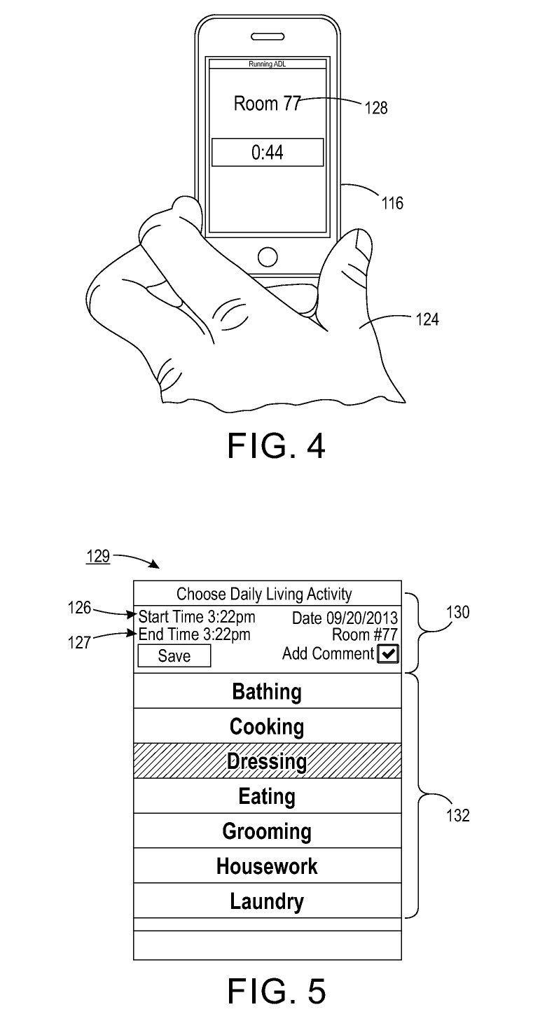

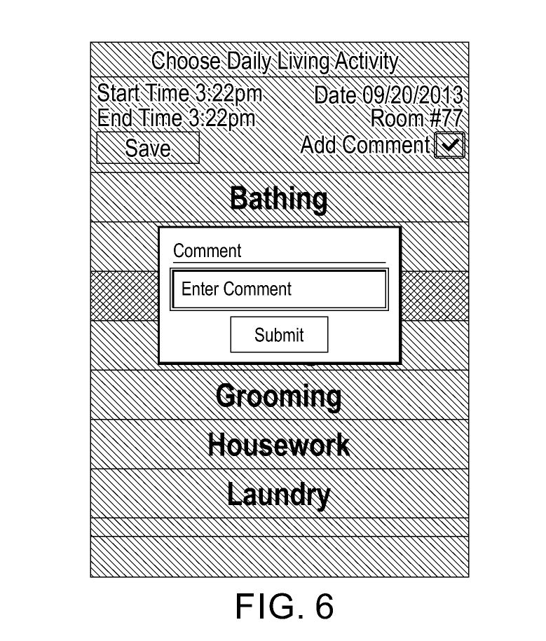

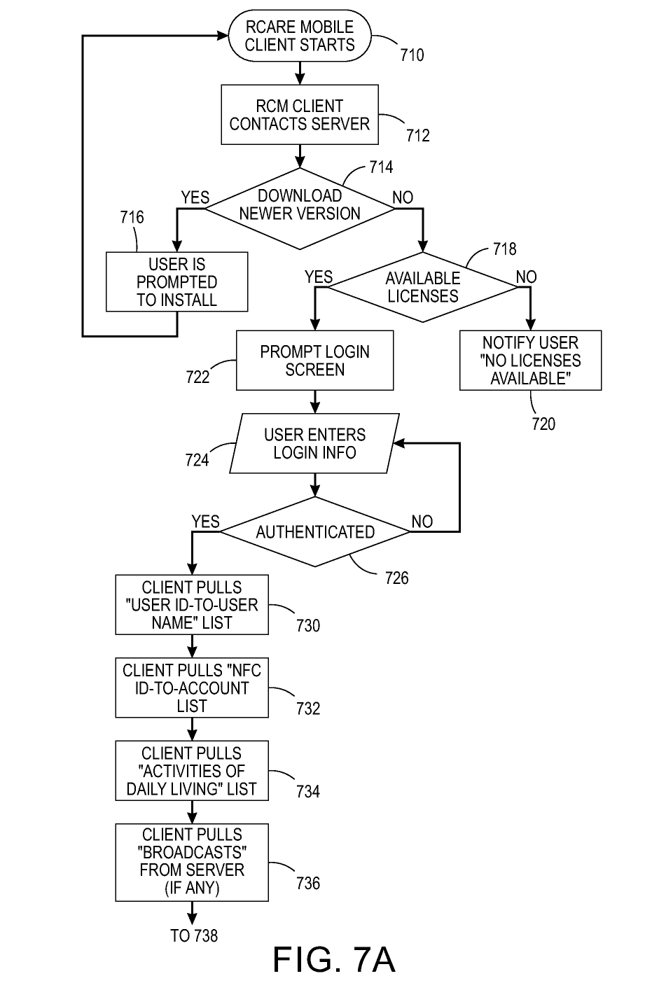

Having described the various components in the system, attention is now turned to a description of a method for care monitoring. In the case where the caregiver responds to an alert or request received on a hand held device such as a smart phone, for example, the response timer stops and the time of response is recorded upon arrival, as seen in FIG. 3. More specifically, the caregiver may initially respond that they will handle the call by tapping or otherwise selecting a “Got It” button on the hand held device. The “Got It” response is then transmitted not only to the central controller via the Wi-Fi, but the Got It response is also made available to others that received the initial request, so that they know that the request is being handled. The caregiver's actual response (e.g., in the room or with the resident) is further recorded when the caregiver positions the smart phone, running a NFC application, in close proximity to the passive NFC tag 118. In one embodiment, the NFC tag may be one that has been previously programmed with a unique ID and affixed to a surface within a resident's room, a common room or other fixed location, or attached to a mobile transportation device such as a resident's wheelchair. Electromagnetic energy from the hand held device 116 (e.g., a NFC enabled smart phone) activates the NFC tag 118 to radiate a RF signal. The signal is then received by a RF transceiver in the hand held device. In other words, the tag detects the RF signal emitted by the hand held device in proximity to the tag, and in response activates RF signal transmission of data from the transmitter in the tag to the handheld device. Upon receiving data from the tag, the hand held device records the data from the tag (at least a unique identifier for the tag), thereby recording the fact that the caregiver was in proximity of the tag at a specific time. Upon a first “swipe” of the handheld device near the tag, a start time is recorded (see display field 126). A second swipe upon completing the requested services records the completion or end time (e.g., display field 127), which may or may not be displayed on the caregiver's device. As an alternative, an elapsed timer may be employed on the hand held device, and upon completion of the services the user stops the timer. In either case, the hand held device creates a service record in its memory that, as illustrated in FIG. 4, stores the location (determined from the tag's identifier, or via manually-entered account information associated with a resident), as well as the start and stop (or elapsed) times for the services to be provided by the caregiver to the resident. Additional information that would be included in the record would be the caregiver's ID, as well as notes/comments that the caregiver enters (see comment checkbox in the displayed interface of FIG. 5). Subsequently, either by real time or scheduled transmission, the particulars of the service record (e.g., a record created in response to the call for assistance event) are sent or transferred to a database associated with controller 102 for storage. The stored data can then either be processed locally or forwarded to a central corporate computer by conventional transmission means to be processed and analyzed for anomalies occurring outside of the defined parameters. It will be appreciated that individual and/or team performance metrics can also be correlated from this information to analyze performance, eliminate inefficiencies and possibly to identify opportunities for corrective action.

Attention is now turned to FIG. 5, where an image of an exemplary user interface 129 of the hand held device depicts a home screen for initiating or editing a service delivery record. As will be appreciated, the user interface of devices such as smartphones may be touch-screen devices with virtual keyboards of devices with manual button-type keyboards to allow a user to make selections and/or enter text-based information such as comments, details of services, resident information, etc. Starting at the upper most area of the display 130 the start/stop (elapsed) times and date of the assistive event are shown. Additionally the actual room number, or location, where the assistance was provided is indicated. As previously noted, the location information (e.g., Room Number) is a function of the unique identifier in the tag, and is programmatically available to the hand held device via the application operating on the device or via a list containing such information that is accessed by the application, and periodically updated on the device by the controller. The main portion of the display 132 shows a pull down menu interface that can be selected (see highlight of “Dressing” activity) to indicate the function that was preformed on that date, at that time, in that location. In the event that there is need for a comment (e.g., an atypical situation requiring additional time, need to note the resident's characteristics or preferences, etc.), a text entry feature such as a keyboard may be used to record the information. Such a feature is not intended to replace the resident's health record, but may be employed to supplement such information in certain circumstances.

At some point after the services have been provided, the hand held device 112 (e.g., 110, 114, 116) transmits or transfers data to the controller 102, the service record information for analysis and/or aggregation. The controller operates to aggregate device information including run-time of activities, tasks accomplished per activity, and user identification. The aggregation operation will correlate and/or store data supplied by the enabled hand held devices, enabling subsequent review of activities using one or more of the aggregation categories noted.

Having described a general embodiment of the monitoring system and method, attention is now turned to an exemplary system. In one embodiment, the RCare mobile system includes a networked central controller 102, referred to as the R-Cube Wireless Emergency Response and Monitoring System (R-Cube) as described in the R-cube Monitoring System Manual (© 2011 Response Care Inc.), hereby incorporated by reference in its entirety. The R-Cube is designed as a Linux-based appliance that provides connectivity to various input monitoring devices such as personal transmitters, check-in devices, wall-mount transmitters, door-mount transmitters which may be in radio (RF) communication, via a master receiver, or hard-wire communication with the R-Cube appliance. Output communications may include pagers, cellular and digital communication devices such as smartphones, text radio devices, lighting, as well as a range of personal computing devices such as workstations, laptops, tablets and the like. In one embodiment, the R-Cube appliance includes a VIA C7 processor operating under programmatic instructions stored in memory, and having I/O capability that is further extended via wireless and radio-frequency (RF) interfaces.

The R-Cube appliance receives resident alerts from devices, anytime, anywhere, and interfaces with R-cube web application for 24/7 system monitoring. In a rack-mounted or standalone configuration, the appliance comprises a microprocessor such as the VIA C7 @ 1.0 Ghz and associated memory (e.g., 1 GB PC5300) and data storage (e.g., 160 GB). The appliance may further include various ports and connectors to enable other devices to be operatively connected to the appliance. Such devices may include a mouse, keyboard, display port (e.g., VGA), RS-232 COM port(s), network (Ethernet) ports, and USB ports. Connected to the R-Cube appliance is a Master Receiver (MR-500), which receives information via signals at 922 MHz from locators and repeaters, and then transmits signals through a serial cable to the R-cube appliance for processing. The master receiver supports up to a total of 4096 locators (LT-490) and repeaters (RP-990). The LT-490 Locator receives signals at 433.92 MHz from wireless transmitters and retransmits such signals at 922 MHz to the repeater (RP-990) and/or master receiver (MR-500). The RP-990 repeater increases the range of a locator network and receives signals at 922 MHz from locators (LT-490) or other repeaters and retransmits at 922 MHz to another repeater and/or the master receiver (MR-500).

In the disclosed embodiments, the R-Cube appliance is responsive to prompts, such as dynamic signals from a wearable transmitter (WTC) or emergency pull cord (BP-7R) alarm, as well as a pre-scheduled task or request for assistance from a resident. Once the controller 102 detects a call for service the operating system and programmatic code operating on the controller makes a determination as to (i) the nature of assistance required, (ii) the preferred responder and (iii) the location of the resident in need of assistance. Subsequently a message or prompt is transmitted to one or more caregivers. At the same time, the system may record a time at which the prompt was sent to the caregiver(s).

Generally speaking the response receiver is a network node consisting of one or more of the following output devices; laptop 122, desktop 108, or a tablet computer 114 or preferably a hand held wireless devices such as mobile phone 110 or smart phone 116 carried by the caregiver(s). The server 102 may employ an MCube operating the following services:
Ejabberd (Service A)—is the service that is used for user-to-user text messaging in the form of text and asynchronous broadcasts (defined as customized text messages). This service is also used for server-to-user text messaging. Server-to-user messaging communications are used when the server needs to tell the RCare Mobile phone device to update all or any of the following (incident list, NFC-to-account list, user-to-name list).

### EXAMPLE1

Server-to-user text in format JSON: {“actions”:[{“type”:“sync”, “option”:“incidents”}]}
How phone responds: Since the phone sees that the text is in JSON format and not a normal text, it will pull down from the CUBE whatever options are listed. In this case, the phone will see that the server wants it to do a “sync incidents” and will trigger the pull down of the last 10 incidents.

### EXAMPLE2

Server-to-user text in plain JSON: “Please exit the building”
How phone responds: Since the phone sees that the text is not in a JSON format, it will just display it as if it was any other text message.
Asterisk (Service B)—is the service that handles SIP/Voice (VOIP)
RCube Services (Service C—Cube & HTTPS)—web pages are used for each individual action that a phone can do. When a phone is told to execute action “sync incidents” the phone knows that it has to access the webpage “get_incidents.php” on the CUBE to get the last ten incidents.
Incidents
User-to-Username list
NFC id-to-account list
ADLs list
Timezone settings
Emergency Info
DNS

In general, the RCare mobile application is installed on any Android device although for full functionality, the device should include NFC and Session Initiation Protocol (SIP), the latter being suitable to enable Voice Over IP (VOIP) functionality on the user devices. For use with the system, the domain name service (DNS), which the phone is configured to point to, needs to be configured to resolve ‘rcm.rcareinc.local,’ where controller 102 (e.g., rcm.rcareinc.local) is resolvable (Service D—the domain name service running on either the CUBE or any other server that is configured to resolve the hostname “rcm.rcareinc.local”), and the user logs into the RCare mobile application by authenticating to the services as described more fully below. In one embodiment, a voice preference may also be enabled on the user device(s), and if so, then RCare mobile registers to Service B. Once a user is logged in, the device immediately requests all services (Service C), and then Service A will send specific asynchronous broadcasts to notify the device (RCare mobile application) of changes.

The mobile devices are preferably suitable to activate and receive information from the near field communication (NFC) wireless tag 118 in order to provide full functionality. In one embodiment an Android OS phone is employed to work with the R-Care Mobile application. Typically, the device will have the Android OS (e.g., 2.3.3+, preferably 4.0+) and must have near-field communication (NFC) as well as Wi-Fi (802.11b/g/n). The data sent from the NFC tag to the hand held device includes a unique identifier in the form of text or numbers, which is associated with a patient account and/or location by a data list (see NFC ID-to-Account” list in operation 732). In the current embodiment, the mobile device operates under control of the RCare Mobile application, which is used for tracking and recording activities of nurses, aides, housekeepers, etc. For example, the application assists in determining when someone enters into a specific room of a resident, what tasks were accomplished, and when they exit.

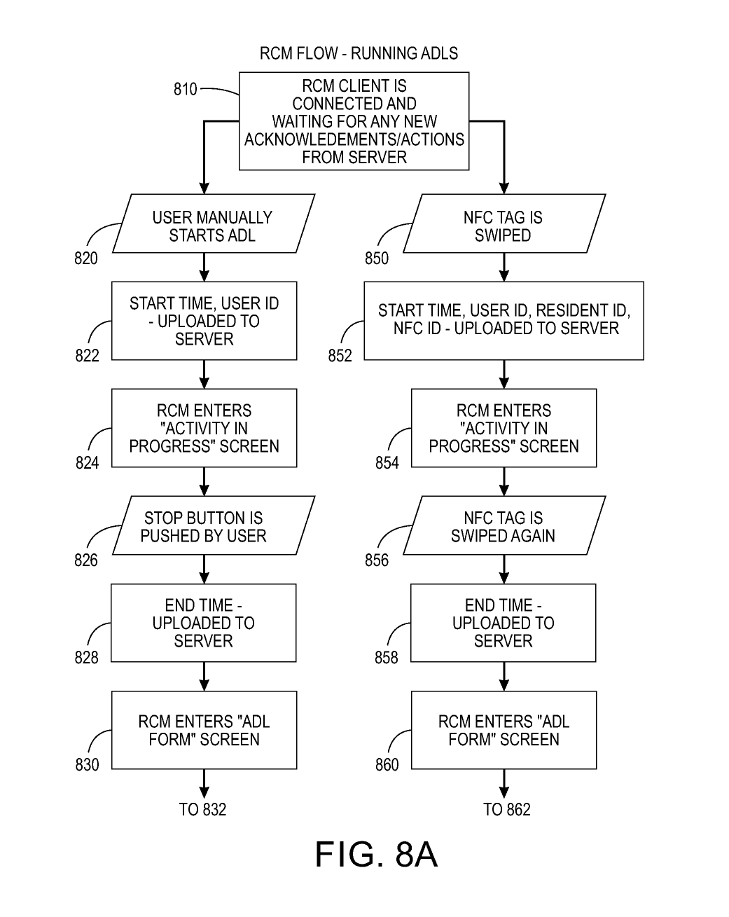

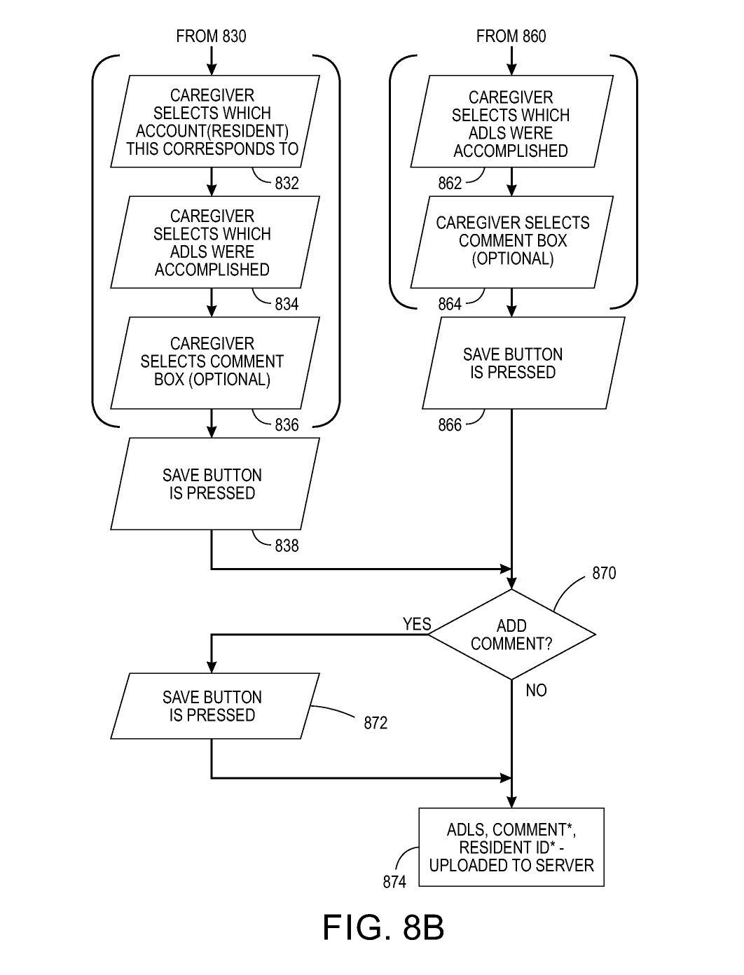

Referring to FIGS. 7A-8B, the operation of the client or device-specific application is initiated at operation 710, where the mobile client is started. Via the wi-fi the device contacts the server (operation 712), and determines via test 714 whether the device needs to update the R-Care Mobile client software. If so, processing continues at operation 716. When the software is up to date, the license status is checked at test operation 718, and in the event no license is found, the user is notified via operation 720. Assuming a valid license is detected, the user is then prompted to login at operations 722-726, and assuming a user is authenticated at test 726, the login is completed and processing continues at operation 730. Beginning at operation 730, the mobile application retrieves or pulls data from the R-Care controller, particularly including a number of lists from database repositories maintained in the controller. For example, at operation 730 the client application pulls a list that provides “translation” of User IDs to User Names for use by the application in the messaging buddylist. All logged in users are shown on the screen with their actual names and not username. Also, when chatting with other caregivers, the from/to fields are populated with the user's actual names and not usernames whenever possible. Finally, when a caregiver calls another caregiver, both the caller and callee can see the actual name of the person they're talking with. At operation 732, the NFC ID to account list is pulled to enable the application to match a scanned NFC tag identifier with a particular patient account. Operations 734-736 similarly retrieve additional information from the controller and its associated memory and databases.

A further representation of the pulling operations 730-734 are depicted as part of operations 750-754, respectively, where the operations represent the different types of broadcast the controller can send at any given time to the phones or similar devices. As an example, please consider the following broadcasts, which include text messages sent from the controller to the phone, although these text messages are hidden from the user:
If the controller wants the phone to pull down the last ten INCIDENTS it will send the following broadcast:
{“actions”:[{“type”:“sync”, “option”:“incidents”}]}
If the controller wants the phone to update its NFC-TO-ACCOUNT list it will send the following broadcast:
{“actions”:[{“type”:“sync”, “option”:“nfcs”}]}
If the controller wants the phone to update its USER-TO-NAME list it will send the following broadcast:
{“actions”:[{“type”:“sync”, “option”:“users”}]}
If the controller wants the phone to update its ADLS list it will send the following broadcast:
{“actions”:[{“type”:“sync”, “option”:“adls”}]}

At operation 738, the most recent incident list is pulled from the controller, and the application then processes the incidents list at 740 to determine whether any incidents remain active. If so, the user is notified (“alarmed”) of an open or active incident at operation 742. Once notified, or if no incidents are determined to be open at operation 740, the application enters an idle or wait state at 744 where it awaits notification of a newly reported incident as will now be described relative to operations 760 and 770. At 760 and 770, server sent actions are reflected. For 760, the action is a broadcast from the controller 102, where the client application pulls or retrieves the broadcasts from the server at 762, and if there are broadcasts as detected at operation 764, the user is alerted as represented by operation 766. For incidents, as reflected in 770, the incidents list is retrieved at operation 772, and any active incidents are identified at operation 774. If there is an active incident, the application alarms or notifies the user as reflected in operation 776. The operations in 760 and 770 are intended to be continuously running, but the particular alerts or alarms may be deferred for a user's device if the user is already attending to another patient or is otherwise occupied, out of service, out of range, etc.

As reflected in FIGS. 8A-8B, the RCare mobile application operates at 810 to await any new prompts provided from the RCare controller 102, and is also responsive to either manual entries or NFC tag initiated entries as will now be described in more detail. In the situation where a prompt is received (broadcast) from the server, the service would send specific asynchronous broadcasts to notify the RCare mobile application of updates, and thereby cause the application to prompt a user in some instances. More specifically, when the phone or device receives a broadcast from the server it does not always “prompt” the user. But, if it's an Incident broadcast (see INCIDENTS broadcast above) the phone will pull the last ten incidents. After inspecting the ten incidents, If any incidents are active the phone will show a red icon on the top notification bar and vibrate/sound every forty-five seconds by default. This will continue until the phone receives another Incident broadcast and there are no active incidents when it pulls the last ten incidents.

As noted above, the prompt may be responded to by the user making a selection and that selection can then be reported to the server so that the incident or prompt can be changed from “active” to “inactive.” The response may also be triggered as a result of the user swiping the device near the NFC tag in order to confirm that the user has responded to the requested location.

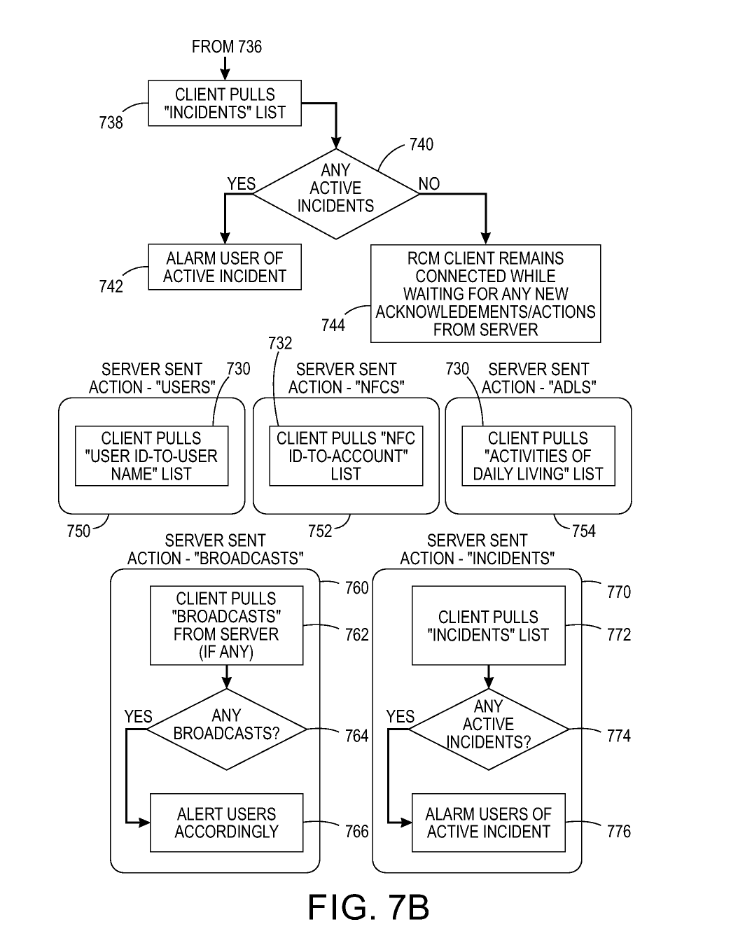

In operations 820-838, the RCare mobile application initiates a manual activities of daily living recording process at operation 820, and at 822 the initiation time and device user's ID are uploaded to the server and an “activity in progress” screen is displayed at operation 824. Upon completion of the activity, the user selects the stop button on the activity in progress screen, operation 826, which causes the completion time to be uploaded to the server at 828 and the activities of daily living screen is then presented to the user (see e.g., FIG. 5) in order to enable the user to select the activity that was completed (834), as well as the patient or account (832). The user is also prompted to add any comments, operation 836 and FIG. 6, before the information is saved and then later uploaded to the server (controller 102) via the Wi-Fi or other network connection at operation 874.

In an alternative operating mode, the activities of daily living recording is initiated by a user swiping the device near an NFC tag as reflected at operation 850 of FIG. 8A. Upon sensing the NFC tag and its ID, the start time, user ID and resident ID associated with the tag is uploaded to the server. Next, as reflected in operation 854, an “activity in progress” screen is displayed. Upon completion of the activity, the user once again swipes the device near the NFC tag, operation 856, which causes the completion time to be recorded by the application and uploaded to the server at 858, and the activities of daily living form screen is then presented to the user at operation 860 (see e.g., FIG. 5), which facilitates the user's selection of the activity that was completed (864). Notably, when the activity record has been initiated by swiping an NFC tag, the patient or account data is pre-determined by the application from the NFC ID information pulled from the server, and the information is automatically populated into the device record for uploading to the server upon completion. Once again, the user is prompted to add any comments, operation 864 (e.g., FIG. 6), before the information is saved (operation 866) and then uploaded to the server (controller 102) via the Wi-Fi or other network connection at operation 874. With regard to adding a comment, after hitting the save button the user is prompted to enter the comment if the comment check box was previously checked.

It will be appreciated that the use of NFC tags, while described relative to a single patient's room may also be used for multiple patients within a room by positioning multiple NFC tags within a room—such as adjacent a patient's bed or area within a larger room. Of course, each NFC tag would preferably be easily distinguishable as to which resident it represents or is associated with. Tags may also be associated with particular patient's themselves, or possible their wheelchairs or other mobility devices so that caregiver's could swipe the tags associated with particular patients or residents.

In situations where a patient or resident needs to be assisted while in a public gathering area generic zones may be associated with certain NFC tags wherein if it is scanned, the RCare mobile application will not display the room number but the zone. For further determination as to whom that activity referred to, the caregiver would then input that information in their comments.

As will be appreciated from the foregoing example, the system will need to provide Wi-Fi coverage throughout facility to facilitate communication between the RCare mobile device/application and the serve, although it may also be possible to employ convention 3G/4G data communications via mobile networks.

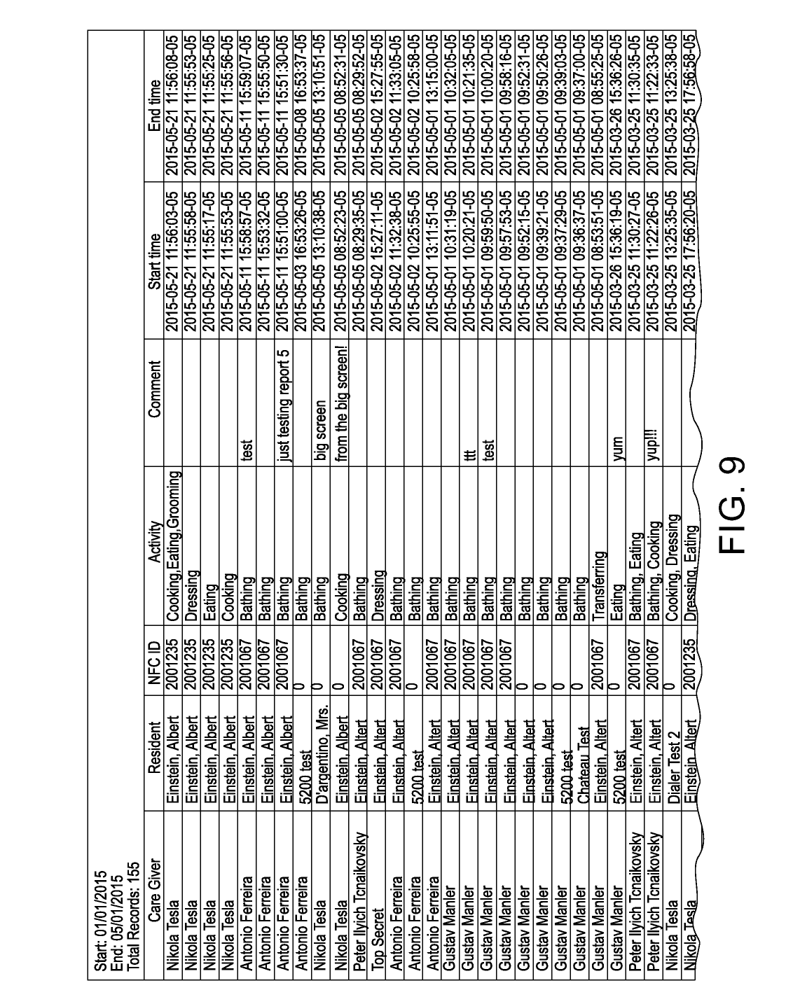

As noted above in the general description of the system, the RCare mobile system monitors and records information relating to the ADLs. By reporting the information from the applications back to the server, the server itself can collect data relating to the provision of services to patients or residents. Moreover, the server, or an associated computing device such as a workstation can access such information and/or compile information comprising: run-time of activities, tasks accomplished per activity, and user identification. The reports such as depicted in FIG. 9 provide such data. Moreover, the daily living activity data can be stored and retrieved from the RCare mobile enabled devices so that it can be further aggregated, analyzed, compared, etc. While the disclosed system is intended to provide a time management tool to oversee the process of caring for residents, it can also serve as a prompting/scheduling device (e.g., medication delivery schedule) whereby a schedule is established for one or more residents and the controller automatically generates and transmits a message indicating the needed service (e.g., confirm Resident X has taken medication, and optionally dosage and time). While dispensing systems are commonplace in skilled nursing facilities they are typically not required in senior or other assisted living environments as the resident is expected to maintain their own medications. However, the aforementioned embodiment has the potential to add value where scheduled services can be pre-arranged and a prompt is sent out from the central controller directly to the caregiver (and optionally the resident as a reminder).

It should be understood that various changes and modifications to the embodiments described herein will be apparent to those skilled in the art. Such changes and modifications can be made without departing from the spirit and scope of the present disclosure and without diminishing its intended advantages. It is therefore anticipated that all such changes and modifications be covered by the instant application.

What is claimed is:

1. A system for monitoring and recording the administration of services within a care facility, comprising:
a plurality of tags, each tag including a radio frequency (RF) signal detector operatively associated with a static data storage device, wherein each static data storage device includes a unique identifier, and where said tags are permanently affixed at prescribed locations to provide a wireless data read feature when an RF signal is received;
a hand held communication device, said hand held device including a housing, a memory, a microprocessor, a user interface, a start/stop timer, a real-time clock function, a RF transceiver and a battery, and where data transmission from said RF signal detector to said handheld device is activated by said hand held device being placed in proximity to said RF signal detector, wherein the data transmitted from said RF signal detector includes at least the unique identifier information; and
a central processor suitable for communicating with each hand held device and receiving a stored accumulation of resident care data initially received from said static storage device and stored on said hand held communication device, wherein the central processor is capable of storing and further processing the data received from each hand held device, including reporting such data, and
where in response to a services prompt from said hand held communication device, a user responds to the services prompt and in doing so activates the RF signal detector to initiate a record of service delivery.

2. The system according to claim 1 wherein said hand held device is a mobile phone.

3. The system according to claim 2 wherein the mobile phone is a smart mobile phone.

4. The system according to claim 1 whereby said data storage device is a Near Field Communication memory device.

5. The system according to claim 1, wherein the record of service delivery includes an activity.

6. The system according to claim 5, wherein the activity is an activity of daily living.

7. The system according to claim 5, wherein the record of service delivery further includes time data based upon the time the hand held device was placed in proximity to said RF signal detector to activate transmission from said RF signal detector to said handheld device.

8. The system according to claim 5, wherein the record of service delivery further includes additional information entered by the user via the user interface.

9. A method for tracking performance of resident services, comprising:
transmitting a prompt to a caregiver's hand held device from a central computer station;
the caregiver responding to the prompt;
passing the hand held device near a tag associated with a resident's specified location, said tag, in response transmitting over a radio frequency (RF) to the hand held device at least an identifier permanently stored within a memory associated with the tag;
in response to the RF transmission initiating an event timer in the hand held device;
the caregiver responding to the prompt;
passing the hand held device near the tag associated with the resident's specified location in order to stop the event timer in the hand held device;
recording service delivery information including the tag identifier, as well as the start and stop times in memory in the hand held device; and
relaying the service delivery information to said central computer station.

10. The method of claim 9, wherein the central station, upon receiving the service delivery information is able to generate a report of such information, including the nature of services delivered by the caregiver, duration of services, date, caregiver ID, and caregiver notes.

11. The method of claim 9, wherein service delivery information further includes information selected from the group consisting of: prompt information, duration of services, date, caregiver ID, and caregiver notes.
